(19) United States
(12) Patent Application Publication
(10) Pub. No.: US 2021/0345605 A1
(43) Pub. Date: Nov. 11, 2021

(54) BIOLOGICAL PEST CONTROL AGENT

(71) Applicant: Citeq B.V., GRONINGEN (NL)

(72) Inventor: Adrianus Cornelis VAN DER GRAAF, GRONINGEN (NL)

(21) Appl. No.: 17/285,936

(22) PCT Filed: Oct. 22, 2019
(86) PCT No.: PCT/EP2019/078733

§ 371 Date: Apr. 16, 2021

(30) Foreign Application Priority Data
Oct. 26, 2018 (NL) 2021893

(51) Int. Cl. A01N 25/00; A01N 25/12; A01N 63/50; A01N 25/30

(52) U.S. Cl. CPC A01N 25/006; A01N 25/30; A01N 63/50; A01N 25/12

(57) ABSTRACT

The present invention relates to a biological pest control agent that combats parasitic larvae, that may inhabit cultivation substrate, through enzymatic digestion of the larvaes interior upon ingestion, preferably using proteases and/or chitinases. The present invention can be used to replace current available pesticides and can be incorporated in pest management for horticulture and agriculture.

### BACKGROUND OF THE INVENTION

Increasing advances in transportation has allowed the horticulture and agriculture to start using cultivation substrate manufactured all over the world. There have been increasing problems with non-native parasitic mosquito larvae that impair plant (i.e. Orchids, Phalaenopsis) cultivation. Research showed that these mosquitos and their larvaes originate from South- and Central America.

Orchids for example are grown in greenhouses at a temperature of about 28° C. for about a year. Because of the relatively high temperature, pests grow and reproduce fastly.

Thus far conventional pesticides have proven to be ineffective in combating these larvae. In addition, other pest management techniques, such as trapping the mosquitoes with a light trap provide insufficient protection against the current larvae infestation.

Native parasites have been showing increasing resistance to traditional chemical pesticides. Alternative pest control agents are therefore always necessary. Further, there is an increasing need for biological pest control agents.

### SUMMARY OF THE INVENTION

The current invention provides an effective biological pest control agent, and to a biological method for controlling pests. The current invention in particular provides an effective agent against parasitic mosquito larvae (i.e. larvae from species of the genera Bradydia, Bradysia, Keroplatidae, Lycoriella, Lyprauta, Orphelia, Proceroplatus, Tipulidea, Sciara.) or larvae in general that reside in the cultivation substrate.

The current invention therefore provides an effective biological pest control agent for controlling parasites.

The invention provides a biological pest control agent comprising particulate material, which particulate material comprises (i) one or more enzymes that cause—when ingested—the internal of the larvae to be significantly destroyed, (ii) at least one sweetening agent suitable to attract the larvae to ingest the particulate matter, (iii) at least one binder, which allows the particulate matter to substantially stay intact when present in humid soil.

It has been shown that this biological pest control agent and the method of treatment exerts it efficacy through ingestion of the biological pest control agent by the larvae. After ingestion the larvae are killed by an efficient enzymatic digestion of the larvae's interior.

In U.S. Pat. No. 6,663,860, it is disclosed to combat insects in general, like ants and cockroaches, with a solution comprising proteases. However, no application in agriculture or horticulture is described. The liquid formulation would not be effective on soil, as it would be degraded almost instantaneously.

In FR2958500, a composition is described comprising proteases and chemical pesticides. This formulation is not a biological pest control agent.

WO2017/127630 describes combatting water borne insect larvae, wherein bacterial suspensions are mixed with nanoparticles, such that the bacteria—which are insecticidal towards these larvae—remain in suspension.

WO2011/140106 describes enterically coated pancreatic enzyme particles for medicinal use.

WO1992/11347 describes enzyme containing granules for washing or cleaning agents

WO02000/40689 describes low density materials to prepare detergent containing granules for washing or cleaning agents.

### DESCRIPTION OF THE PREFERRED EMBODIMENTS

The invention provides a biological pest control agent in the form of particulate material comprising (i) one or more enzymes that cause—when ingested—the internal of the larvae to be significantly destroyed, (ii) at least one sweetening agent suitable to attract the larvae to ingest the particulate matter, (iii) at least one binder, which allows the particulate matter to substantially stay intact when present in humid soil.

Effective enzymes for implementation of this invention preferably comprises protease(s), chitinase(s) or a mixture thereof from either a synthetic or natural origin.

Suitable proteases are commercially available. Proteases comprise for example serine or cysteine, threonine, aspartic, glutamic and metallo proteases. Preferably serine proteases are used because of their availability. Serine proteases are well known in the detergent industry. The preferred proteolytic enzymes found in detergents are nonspecific serine endoproteases (e.g. subtilisin) with a preferred cleavage on the carboxyl side of hydrophobic amino acid residues, but capable of hydrolyzing most peptide links. Subtilisins are defined by their catalytic mechanism as serine proteases. Their amino acid sequence and three dimensional structure can be differentiated from the other serine proteases, such as chymotrypsin, carboxypeptidase and Peptidase A from Escherichia coli. The catalytic triad of subtilisins consists of aspartic acid, histidine and serine. Although the size of subtilisins varies from 18 kDa to 90 kDa, all the subtilisins used in detergents have a size of approximately 27 kDa. The success of subtilisins is based on several factors, including their high stability and relatively low substrate specificity—features common in extracellular proteases.

Suitable proteases are for example described in Current Opinion in Biotechnology 2004, 15:330-334, mentioning about 15 commonly used proteases. Suitable proteases are for example also described in US2002/177220.

For use in the biological pest control agent of the present invention, non-specific proteases are preferred.

Although the proteases used in the detergent industry are preferred because of their efficacy and low price, the stability requirements are less stringent in the present invention, therefore other proteases can be used.

Proteases, including serine proteases, may have different pH ranges where optimal activity is noted. Therefore, different classes can be recognized, being acid protease enzyme, alkaline protease enzymes and neutral protease enzymes. The optimal activity can be of importance in the soil and the pH in or around an insect or other living harmful element for the plant in the soil or on the plant parts above the ground.

Proteases used in detergents generally are alkaline proteases with a activity range between pH 6 to 10, which is generally sufficiently wide for good activity. Yet, in order to have a universally applicable product, it is preferred to use a mixture of serine proteases, wherein the proteases together are active over a pH range of between 4 and 10.

Suitable chitinases are chitinolytic enzymes, which irrespective of their production source can hydrolyze the integument of insects. Suitable chitinases preferably are ones originating from plants, fungi. A variety of suitable chitinases are described in RRJMB 2014; 3:27-32, and in AIMS Microbiology (2017) 3:689-705

The enzymes may be home grown or bought. Proteases are for example available from Shanghai Ruizheng Chemical Technology Co ltd, Henkel AG, Novozymes, Genencore and the like. Chitinases are for example available from Wuhan Golden Wing Industry & Trade Co., Ltd.

To achieve the objective of larvae ingestion the described particulate matter comprising enzymes or enzyme mixture also comprises a sweetener component. This sweetener component may include polyvinylpyrrolidone, starch, starch derivatives, polys- or monosaccharides or derivatives thereof, and mixtures thereof.

The pest control agent is in the form of fine granules or powder, and therefore comprises an binder allowing the particles to stay largely intact in a moist cultivation substrate. Such a binder preferably is a polymeric hydrophilic material like for example polyvinylpyrrolidon, hydroxyethylmethylcellulose, starch and the like.

In a preferred embodiment, the binder also is effective as sweetening agent.

The pest control agent further may comprise a surfactant component, that may contain surfactant(s), detergents, detergent stabilizer(s) or mixtures thereof (hereinafter together named surfactant). The surfactant can be instrumental to have the components of the particles dissolve before drying/granulation. It may be useful to use more than one surfactant. Suitable surfactants are anionic, cationic or further nonionic surfactants.

Typical surfactants, or surface-active agents, are alkyl sulphate salts, such as diethanol ammoniumlaurate sulphate, alkylarylsulphonate salts, such as like sodium dodecyl benzene sulphonate, alkylphenol-alkylene oxide addition products, such as nonylphenol-C18 ethoxylate; alcohol-alkylene oxide addition products, such as tridecyl alcohol-C16 ethoxylate; ethoxylated fatty acids such as castor oil ethoxylate (EO 25 or 40), soaps such as sodium stearate; alkylnaphthalene-sulphonate salts such as sodium dibutylnaphthalenesulphonate; dialkylesters of sulphosuccinate salts, such as sodium di(2-ethylhexyl) sulpho-succinate; sorbitol esters such as sorbitol oleate; quaternary amines, such as lauryl trimethylammonium chloride; polyethylene glycol esters of fatty acids, such as polyethyleneglycol stearate; block-copolymers of ethyleneoxide and propylenenoxide; salts of mono and dialkyl phosphate esters; polyamine-fatty acid condensates; random polyester condensates; lecitine or modified lecitines; mono- or di-glycerides and the like.

Preferred surfactants include sodium dodecyl sulfate, polyethyleneglycol stearate and sodium stearate.

The biological pest control agent preferably comprises a relatively high amount of active ingredients (enzyme preparations and sweetening agents).

Preferably, but in particular in case the binder and the sweetening agent are the same compound, the enzyme preparation and sweetening agents comprise about 80% or more of the biological pest control agent. More preferably, these components comprise about 90 wt % or more of the total composition. However, inert diluting (bulking) agents can be used, and may lower the effective concentrations of the enzyme preparation and sweetening agents, without adversely effecting the efficacy of the pest control agent. As explained below, the enzyme preparation generally contains proteases in amounts between 2-50% and an enzyme preparation with high amount of protease may comprise additional bulking agent.

The enzymes preferably are used in the biological pest control agent in an amount of between about 0.2 wt % to about 50 wt %. More preferably, the amount is between about 1 wt % and 30 wt %, and even more preferably between about 1 and 20 wt %. Enzymes are generally available as preparation with remainders of cell materials and/or bulking agents. The effective concentration in an enzyme preparation may be 2% or higher, preferable 5% or higher, like for example about 5% to about 20%, such as for example about 10%. More concentrated preparations can be used, like for example 20-50% protease enzyme containing preparations.

An enzyme preparation may be used in amounts in the biological pest control agent in an amount of between about 3 wt % to 80 wt %. More preferably, the amount is between about 5 wt % and 70 wt %, and even more preferably between about 20 and 60 wt %.

The sweetening agent preferably is used in the biological pest control agent in an amount of between about 3 wt % to about 80 wt %. More preferably, the amount is between about 5 wt % and 70 wt %, and even more preferably between about 20 and 60 wt %.

The binder preferably is used in the biological pest control agent in an amount of between about 3 wt % to about 80 wt %. More preferably, the amount is between about 5 wt % and 70 wt %, and even more preferably between about 20 and 60 wt %. This in particular is applicable if the sweetening agent and binder are the same component.

In case the binder is not also effective as sweetening agent, it is preferred to have this component present in an amount of about 20 wt % or less, as it is generally not necessary to use a larger amount of binder to effectively have the properties required. Effectively, the binder, not being a sweetening agent, may be used as bulking agent, in which case the hereinafter described amounts apply.

Bulking agents—if used—preferably are used in the biological pest control agent in an amount of between about 5 wt % to about 90 wt %. More preferably, the amount is between about 5 wt % and 70 wt %, and even more preferably between about 10 and 60 wt %.

A surfactant (or mixture of surfactants)—if present—preferably is used in the biological pest control agent in an amount of between about 0.1 wt % to about 20 wt %. More preferably, the amount is between about 1 wt % and 15 wt %, and even more preferably between about 1 and 10 wt %. A surfactant may have benefit in dissolving and/or dispersing the components of the biological pest control agent during its preparation.

The biological pest control agent can be prepared by mixing the appropriate components, and granulating the mixture. Generally, it is preferred to mill the granules and/or sieve particulate material to the appropriate size.

In one preferred embodiment of the invention, the components are dissolved, suspended or dispersed in water, well mixed, and the water containing mixture is dried. The mixture may be dried over a drum drier, belt drier, through spray drying, in a flash drier, air turbulence mill or the like. As dissolved proteases attack all proteins, including proteases, it is preferred to limit the time that proteases are freely dissolved. Hence, water containing mixture preferably is dried shortly after mixing the proteases. During or after drying, the product may be milled to the appropriate particle size, or this may take place after a drying step.

In a more preferred process, first the binder is allowed to disperse in water and allowed to absorb water. Thereafter, the other components are added and thoroughly mixed, and the mixture is dried.

The biological pest control agent is preferably in particulate form having size smaller than 1 mm, preferably about 0.3 mm or smaller, and larger than about 20 nm, preferably larger than 0.01 mm.

Further methods to prepare insect bait compositions are for example described in U.S. Pat. No. 5,837,273 or EP0254257. Such techniques can be used in an analogous way.

The biological pest control agent preferably is stable in moist substrate for a substantial amount of time, and more preferably exhibits a dissolution time of more than 1 hr in water at 20° C., preferably about 2 hr or more, and even more preferably about 4 hr or more. The particles, if dispersed in water, will absorb water and become gel-like. Yet, the particles are clearly visible as distinguished from the water phase. Stable in this sense means that the particles may swell and/or gel, but do not dissolve to a large extent. The proteases are still sufficiently stable immobilized in the swollen particle to sufficiently preclude degradation such that the pest control agent can be active for several days to several weeks.

The invention furthermore relates to a method of controlling larvae-pest in soil or other solid cultivation medium, by applying the biological pest control agent according to the present invention to the soil.

It generally is sufficient to apply the pest control agent on the soil. However, it is also possible and effective, to mix the pest control agent with the soil, in the upper 20 cm of the soil, like for example the upper 10 cm.

In the method of the invention the amount of biological pest control agent (excluding the amount of bulking agent) applied to the soil or substrate is preferably between about 0.1 to 5 gram per square meter soil, preferably between 0.2 and 2 gram per square meter.

The pest control agent consists of particles with a binder that can absorb water, and will form a gel-like particle, which is relatively easy to be ingested by the larvae or other comparable parasites.

The gel-like particle may slowly dissolve, and when dissolved, the proteases will fastly disappear by autolysis and/or bacterial activity in the soil. Hence, the biological pest control agent of the present invention does not pose a long term burden on the environment.

It is preferred to apply the biological pest control agent a number of times, like 2, 3, 4, 5 or up to 20 times during a growth period of plants, also depending on the total growth period of the plants and the burden of the pest. The period between application may vary, depending on how fast the particles dissolve, the burden and number of parasitic pests and the like. Suitable periods between application include every 2 days apart, at least three days apart, every week or every 2 weeks apart. Preferably, the time between each application is about one week or more, and even more preferred about 2 weeks. Preferably, the period between two applications is 4 weeks or less.

Preferably, the biological pest control agent is applied every week or every two weeks in intensive greenhouse horticulture.

The method of the invention is preferably applied in a greenhouse or the like. The concentrated growth activities in a greenhouse increase the risks of pests, also because of the import of substrate.

The method is effective against most larvae, such as parasitic mosquito larvae, of the genera Bradydia, Bradysia, Diptera, Frankliniella, Homoptera, Keroplatidae, Lepidoptera, Liriomyza, Lycoriella, Lyprauta, Orphelia, Proceroplatus, Tipulidea, Sciaridae Sciara. Further, pests in the family of Acarina (Acari) comprise Prostigmata, Astigmata, and Cryptostigmata. Further Chilopoda Diplopoda, and Symphyla Scutigerella immaculata are pests that can be combatted with the pest control agent of the present invention.

The method is for example very effective against larvae that are parasitic mosquito larvae of Bradydia impatiens, Bradysia coprophila, Bradysia pauper, Lycoriella auripila, Lyprauta chacoensis, Lyprauta cambria or Sciara porothalliorum.

In addition, this pesticide treatment can also combat larvae by enzymatic digestion of its exterior by exposure. In particular if the particles have taken a gel-like texture, touching such particle by a larvae will attach the particle to the larvae, after which the enzymes can be effective. In particular if chitinases are present, the exterior of the larvae will be attacked, after which proteases further destroy the larvae. Such an unique two-way approach is an effective method to combat larvae that are becoming a major problem in the horticulture.

This pesticide treatment can also be effective if sprayed on the leaves and/or stems of plants, as insects may ingest the particles on the leaves, stems etc. as well. Tests have shown that, assuming once a week extensive watering, the particles are present during a two week period.

The biological pesticide can be effective against lice, larvae of Colorado beetle, wireworms, European corn borers, nematodes, eelworms and the like.

In order to effectively apply the insecticide onto plants, it is preferred to disperse the pesticide in water shortly before application, in for example an amount of between 0.1-30 wt % (on 100 weight parts of water), preferably 1-30 wt %, like for example 10 or 20 gram of pesticide in 100 ml of water, and spray the slurry onto the plants. As an alternative, the plants may be sprayed with water, and the powder applied when the plants are still moist. The water on the plants allows the particles to gel and adhere to the stems and leaves.

The application of these particles is advantageous over solutions, because the particles adhere to the plant, and stay intact also with some rain or other leaf spray.

### EXAMPLES

The biological pest control agent was prepared as follows: 50 gram povidone (polyvinylpyrrolidone; available from Sigma) was mixed in 100 ml water, and allowed to absorb water to provide a suspension. Into this suspension, 50 gram of protease protease preparation was thoroughly mixed. The protease preparation comprised subtilin serine protease, and is available from Shanghai Ruizheng Chemical Technology Co ltd; China; the amount of protease in the preparation was between 7-10 wt % as measured with Kjeldahl nitrogen content and SDS-page. This protease is an alkaline protease, having efficacy over the pH range of 6.0-10.5.

The resulting suspension was slightly haze to the eye, but otherwise homogeneous. The liquid was immediately dried using a laboratory drum dryer, and a brittle layer was obtained. The layer was ground in a mortar and sieved over a 0.3 mm screen. As a comparative, a powdery agent was prepared with starch instead of protease.

Some particles were dispersed in a glass of water while stirring for 1 min, after which no further stirring was applied. The particles absorbed water and became gelly. Yet the particles were clearly visible as separate entities up to 4-5 hours.

Two pairs of substrate beds were treated as follows: 1 gram of product as described above per square meter was dusted over the soil directly after planting the orchids on day 0. After 10 and 25 days, while the orchids were growing, the substrate was checked for the presence of larvae and spindles (the cocoons of the larvae). In this greenhouse generally a large number of Sciara porothalliorum larvae were present. In one bed, this was clearly apparent by the presence of larvae and spindles at day 0. The other beds had no visible larvae, but the presence of spindles indicated the presence of larvae as well. On day 7, 14 and 21, the plants were extensively watered through spraying heads. In the meantime, some fertigation was allowed, watering just the soil.

The results show that in particular after 10 days, the soil was clean. After more than 3 weeks, still an improvement was seen, but less outspoken.

TABLE 1

| | Date | | | | | |
|---|---|---|---|---|---|---|
| | Day 0 | | Day 10 | | Day 25 | |
| | Larvae | Spindles | Larvae | Spindles | Larvae | Spindles |
| Group | presence | presence | presence | presence | presence | presence |
| PVP with | Yes | Yes | No | No | No | No |
| protease | | | | | | |
| enzyme | | | | | | |
| PVP with | Yes | Yes | Yes | Yes | Yes | Yes |
| starch | | | | | | |
| PVP with | No | Yes | No | No | Yes | No |
| protease | | | | | | |
| enzyme | | | | | | |
| PVP with | No | Yes | No | Yes | No | Yes |
| starch | | | | | | |

1. Biological pest control agent comprising particulate material, said particulate material comprising
(i) one or more enzymes that cause—when ingested—the internal of the larvae to be significantly destroyed,
(ii) at least one sweetening component suitable to attract the larvae to ingest the particulate matter,
(iii) at least one binder, which allows the particulate matter to substantially stay intact when present in humid soil.

2. Biological pest control agent according to claim 1, wherein the one or more enzymes comprise protease(s), chitinase(s) or a mixture thereof.

3. Biological pest control agent according to any one of the preceding claims, wherein the at least one sweetener component includes polyvinylpyrrolidone, starch, starch derivatives, polysaccharides, monosaccharides, derivatives thereof, or mixtures thereof.

4. Biological pest control agent according to any one of the preceding claims, wherein the at least one binder is a polymeric hydrophilic material like for example polyvinylpyrrolidone, hydroxyethyl methylcellulose, starch or mixtures thereof.

5. Biological pest control agent according to any one of the preceding claims, wherein the binder is also effective as sweetening agent.

6. Biological pest control agent according to any one of the preceding claims, wherein the composition further comprises a surfactant component, comprising surfactant(s), detergent stabilizer(s) or mixtures thereof.

7. Biological pest control agent according to any one of the preceding claims, wherein the composition is in particulate form having size smaller than 1 mm, preferably about 0.3 mm or smaller, and larger than about 1 nm, preferably larger than 0.01 mm.

8. Biological pest control agent according to any one of the preceding claims, wherein the pest control agent exhibits a dissolution time of more than 1 hr in water at 20° C.

9. Method of controlling larvae pest in soil or other solid cultivation medium, by applying the biological pest control agent according to any one of the preceding claims to or in the soil.

10. Method according to claim 9, wherein the larvae are parasitic larvae of Bradydia, Bradysia, Diptera, Frankliniella, Homoptera, Keroplatidae, Lepidoptera, Liriomyza, Lycoriella, Lyprauta, Orphelia, Proceroplatus, Tipulidea, Sciaridae Sciara.

11. Method according to claim 10, wherein the larvae are parasitic mosquito larvae of Lycoriella auripila, Sciara porothalliorum, Bradysia pauper, Bradysia coprophila, or Bradydia impatiens.

12. Method according to any one of claims 9-11 wherein the amount of biological pest control agent, excluding a bulking agent, is between about 0.1 to 5 gram per square meter soil.

13. Method of controlling pests on plants by applying the pest control agent according to any one of claims 1-8 wherein the pest control agent is mixed with water shortly before applying the product, and spraying the slurry onto the plants.

14. Method according to claim 13, wherein the slurry comprises an amount of biological pest control agent of between about 0.1-30 wt %.

15. Method according to any one of claims 9-14, wherein the method is applied in a greenhouse.
